(19) United States
(12) Patent Application Publication
(10) Pub. No.: US 2025/0055817 A1
(43) Pub. Date: Feb. 13, 2025

(54) METHOD FOR PROVIDING CHANNEL GROUP AND ELECTRONIC DEVICE SUPPORTING THE SAME

(71) Applicant: KAKAO CORP., Jeju-si (KR)

(72) Inventors: You Jee Won, Seongnam-si (KR); Ji Sun Lee, Seongnam-si (KR); Ki Yong Shim, Seongnam-si (KR); Jin Young Yang, Seongnam-si (KR); Cho Eun Kim, Seongnam-si (KR); Young Min Park, Seongnam-si (KR); Ji Young Lee, Suwon-si (KR); Su Na Lee, Seoul (KR); So Eun Choi, Seoul (KR)

(21) Appl. No.: 18/798,472

(22) Filed: Aug. 8, 2024

(30) Foreign Application Priority Data
Aug. 10, 2023 (KR) 10-2023-0104922
Aug. 10, 2023 (KR) 10-2023-0104929

(51) Int. Cl. H04L 51/04; H04L 51/48; H04L 51/52

(52) U.S. Cl. CPC H04L 51/04; H04L 51/48; H04L 51/52

(57) ABSTRACT

Proposed is a method for providing at least one channel group by a server. The method may include in response to an interaction from a user terminal requesting creation of a channel group, creating the channel group; in response to the channel group being created. The method may also include creating a default chat channel included in the channel group. The method may further include in response to an interaction from the user terminal requesting creation of a chat channel, creating the chat channel included in the channel group.

### CROSS-REFERENCE TO RELATED APPLICATIONS

This application claims priority to and the benefit of Korean Patent Application No. 10-2023-0104922 filed on Aug. 10, 2023 and Korean Patent Application No. 10-2023-0104929 filed on Aug. 10, 2023, the disclosure of each of which is incorporated herein by reference in its entirety.

### BACKGROUND

### Technical Field

The present disclosure relates to a method for providing channel group, including at least one chat channel, and an electronic device supporting the same.

### Description of Related Technology

Recent online platforms provide a space for users to share information and communicate. These online platforms generally operate on a web-based framework and are implemented using web programming languages and frameworks. Mainly, HTML, CSS, and JavaScript are used to design a user interface, while server-side programming languages like PHP, Python, and Ruby are used to handle data processing and server-client interactions.

Users' posts, comments, and other information are stored and managed on the bulletin boards of online platforms. For this purpose, databases, including relational database management systems (RDBMS) like MySQL and PostgreSQL, are commonly employed. These databases structure information related to posts, enabling efficient searching and management.

Membership management systems of online platforms allow users to sign up, log in, and engage in activities such as writing posts and leaving comments. Thus, the membership management systems are required to handle user account information, authentication, and authorization management. This system verifies user identities and enhances security. The bulletin board of an online platform provides various functionalities to facilitate users' communication. Key features of the bulletin board include writing posts, leaving comments, recommending/disliking, displaying view counts, searching, and categorization/tagging. These features help users effectively share information and exchange opinions.

### SUMMARY

The present disclosure relates to a method and system for creating and providing channel group including at least one chat channel by a user account of a user terminal.

In one aspect, there is provided a method for providing at least one channel group by a server, and the method includes: in response to an interaction from a user terminal requesting creation of a channel group, creating the channel group; in response to the channel group being created, creating a default chat channel included in the channel group; and in response to an interaction from the user terminal requesting creation of a chat channel, creating the chat channel included in the channel group.

The creating of a chat channel included in the channel group may include: creating a first chat channel included in the channel group, based at least partly on an interaction from the user terminal; and creating a second chat channel included in the channel group, based at least partly on an interaction from the user terminal.

The method may further include: creating a channel group address corresponding to the channel group; creating a first chat channel address corresponding to the first chat channel; and creating a second chat channel address corresponding to the second chat channel.

The channel group address, the first chat channel group address, and the second chat channel group address may be Uniform Resource Locators (URLs) or Quick Response codes (QR codes) that contains information providing connection to the channel group, the first chat channel, and the second chat channel, respectively.

The creating of the channel group may include creating at least one of the following: a group link for sharing at least one content and engaging in a group chat with a plurality of user accounts; a one-to-one channel group for engaging in a one-to-one chat with a different user account; and an open profile representing a user account of the user terminal on the channel group.

The creating of the channel group may include: creating the first channel group based at least partly on an interaction from the user terminal; and creating the second channel group based at least partly on an interaction of the user terminal.

The method may further include: creating a first channel group address corresponding to the first channel group; and creating a second channel group address corresponding to the second channel group.

The first channel group address and the second channel group address may be uniform resource locators (URLs) or quick response codes (QR codes) that contains information providing connection to the first channel group and the second channel group, respectively.

The method may further include, in response to an interaction from a visitor account requesting participation in the channel group, allowing participation of the visitor account in the channel group and the default chat channel.

In another aspect, there is provided a server providing at least one channel group, and the server includes a memory storing instructions, and a processor configured to execute the instructions to: in response to an interaction from a user terminal requesting creation of a channel group, create the channel group; in response to the channel group being created, create a default chat channel included in the channel group; and in response to an interaction from the user terminal requesting creation of a chat channel, create the chat channel included in the channel group.

In yet another aspect, there is provided a method for creating a channel group by a user terminal, and the method including: displaying a channel group creation interface for creating the channel group on a screen of the user terminal; in response to an interaction from the user terminal with the channel group creation interface, requesting the server to create the channel group; displaying a chat channel creation interface for creating a chat channel on the screen of the user terminal; in response to an interaction from the user terminal with the chat channel creation interface, requesting the server to create the chat channel; and displaying the channel group, including the chat channel, on the screen of the user terminal.

The method may further include: in response to an interaction from the user terminal with the chat channel creation interface, requesting the server to create a second chat channel; and displaying the channel group, including the chat channel and the second chat channel on the screen of the user terminal,

The method may further include receiving, from the server, a channel group address corresponding to the channel group, a first chat channel address corresponding to the chat channel, and a second chat channel address corresponding to the second chat channel.

The channel group address, the first chat channel group address, and the second chat channel group address may be Uniform Resource Locators (URLs) or Quick Response codes (QR codes) that contains information providing connection to the channel group, the first chat channel, and the second chat channel, respectively.

The channel group may include at least one of the following: a group link for sharing at least one content and engaging in a group chat with a plurality of user accounts; a one-to-one channel group for engaging in a one-to-one chat with a different user account; and an open profile representing a user account of the user terminal on the channel group.

The method may further include, in response to an interaction from the user terminal with the channel group creation interface, requesting the server to create a second channel group.

The method may further include receiving a channel group address corresponding to the channel group and a second channel group address corresponding to the second channel group from the server.

In yet another aspect, there is provided a user terminal creating a channel group, and the user terminal includes a memory storing instructions, and a processor configured to execute the instructions to: display a channel group creation interface for creating the channel group on a screen of the user terminal; in response to an interaction from the user terminal with the channel group creation interface, request the server to create the channel group; display a chat channel creation interface for creating a chat channel on the screen of the user terminal; in response to an interaction from the user terminal with the chat channel creation interface, request the server to create the chat channel; and display the channel group, including the chat channel, on a screen of the user terminal.

### BRIEF DESCRIPTION OF THE DRAWINGS

FIG. 1 is a diagram illustrating an example of a network environment according to an embodiment of the present disclosure.

FIG. 2 is a flow chart illustrating an example of a process for providing a channel group including at least one chat channel according to an embodiment of the present disclosure.

FIGS. 3 to 5 are diagrams illustrating an example of a user interface for creating a channel group according to an embodiment of the present disclosure.

FIG. 6 is a diagram illustrating an example of a user interface in which a channel group has been created according to an embodiment of the present disclosure.

FIGS. 7 to 9 are diagrams each illustrating an example of a user interface for creating a chat channel included in a channel group according to an embodiment of the present disclosure.

FIGS. 10 to 12 are diagrams illustrating examples of a group link, a one-to-one channel group, and an open profile user interface created by a channel group user interface according to an embodiment of the present disclosure.

FIG. 13 is a diagram illustrating an example of a group link user interface according to an embodiment of the present disclosure.

FIGS. 14 to 17 are diagrams illustrating an example of a user interface through which a visitor terminal accesses a channel group or channel according to an embodiment of the present disclosure.

### DETAILED DESCRIPTION

Hereinafter, embodiments of the disclosure will be described in detail with reference to the attached drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

As used herein, the singular forms “a”, “an,” and “the” are intended to include the plural forms as well, unless the context clearly indicates otherwise.

In this application, the described steps may be carried out in any sequence, except in cases where a clearly defined cause-and-effect relationship necessitates a specific order.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

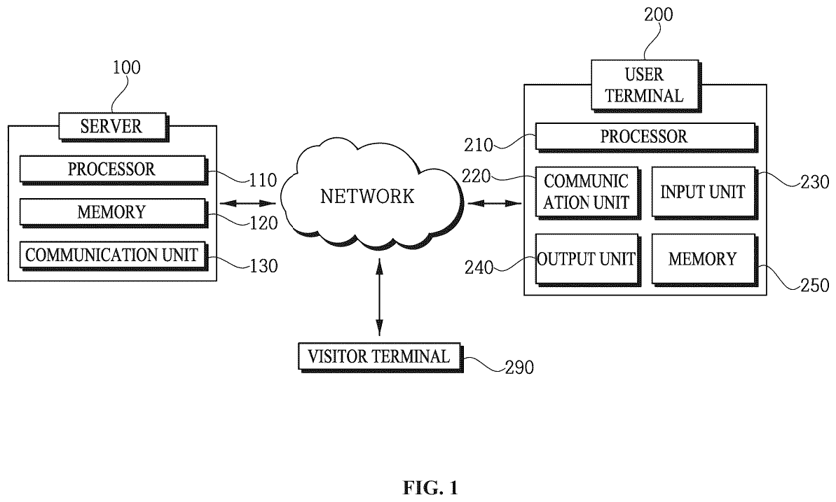

FIG. 1 is a diagram illustrating an example of a network environment according to an embodiment of the present disclosure. Hereinafter, the present disclosure will be described with reference to the attached drawings.

According to various embodiments, a server 100 may be connected to a user terminal 200 over a network. Communication schemes for a network is not limited. The communication schemes may include not only a communication scheme to utilize a telecommunication network (for example, a mobile communication network, wired Internet, wireless Internet, and a broadcast network), but also a short-range radio communication scheme.

According to various embodiments of the present disclosure, the server 100 may be implemented as a computer device or a plurality of computer devices that provide commands, codes, files, content, services, etc. In one embodiment, the server 100 may be an electronic device capable of transmitting and receiving information through communication with the user terminal 200 over the network. Although the server 100 is described as a single server for convenience of explanation, it may be provided as a plurality of servers, each server providing a different function or service.

According to various embodiments, when the user terminal 200 needs to perform a certain feature or service automatically or upon a request, the user terminal 200 may request at least some features associated therewith from the server 100 instead of or in addition to performing the feature or service by itself. The server 100 may execute the requested feature or additional feature and transmit the result to the user terminal 200. The user terminal 200 may provide the requested feature or service by processing the received result as is or additionally. For example, cloud computing, distributed computing, or client-server computing technologies may be used.

According to various embodiments, the server 100 may provide an application related to a channel group including at least one channel (hereinafter referred to as a chat-channel group-related application). Here, the chat-channel group-related application may refer to an Internet space that enables communication or information exchange between Internet users to share interests, hobbies, etc. For example, the chat-channel group-related application may be a platform that supports features or services on social networking sites, regular chat rooms, open chat rooms, email, discussion boards, posts, etc.

The server 100 may include a processor 110, a memory 120, and a communication unit 130. The processor 110 may control the overall operation of the memory 120 and the communication unit 130. According to various embodiments of the present disclosure, the memory 120 functions as a storage medium and may store a number of application programs running on the server 100, and data and commands for operation of the server 100. In one embodiment, the memory 120 may be provided in the form of any of various hardware storage devices such as an ROM, an RAM, a flash drive, a hard drive, etc. or may be provided in the form of web storage. The communication unit 130 may communicate with the user terminal 200 over a network in a wired or wireless manner.

According to various embodiments, the processor 110 may provide a relevant functionality or user interface to allow a general user of the user terminal 200 to create, manage, and modify a channel group in the application on a specific topic or interest. In one embodiment, the processor 110 may provide a channel group creation interface in response to an interaction from a user account of the user terminal 200 requesting the creation of a channel group. For example, after the user account of the user terminal 200 signs up for the chat-channel group-related application, the user account may request the channel group creation interface provided by the application from the server 100. Subsequently, the user terminal 200 may display the channel group creation interface received from the server 100 on a screen of the user terminal 200.

According to various embodiments, the processor 110 may create a channel group based on an interaction with the channel group creation interface by the user account of the user terminal 200. For example, the processor 110 may create a channel group based on an input by the user account of the user terminal 200 regarding the type of channel group (e.g., channel group, one-on-one channel group, open profile, etc.), the openness of the channel group (e.g., open channel group, regular channel group, etc.), the title of the channel group, and a participation condition of the channel group (e.g., age, gender limit, etc.).

According to various embodiments, a channel group may be composed of at least one channel that provides a chatting functionality. For example, a channel group on a specific interest or hobby may be composed of multiple channels. Each of these channels may support features such as chatting between different users, text and image posting, content sharing, information sharing, application announcements posting, recommended posting, etc.

According to various embodiments, the processor 110 may provide a chat channel creation interface in response to an interaction from the user account of the user terminal 200 requesting the creation of a chat channel. For example, after the user account of the user terminal 200 creates a channel group, the user account may request the creation of a chat channel from the server 100. The user terminal 200 may display the chat channel creation interface received from the server 100 on the screen of the user terminal 200.

According to various embodiments, the processor 110 may create a chat channel included in the channel group based on an interaction with the chat channel creation interface by the user account of the user terminal 200. For example, the processor 110 may create a chat channel based on an interaction input by the user account of the user terminal 200 regarding the name of the chat channel, participation conditions of the chat channel, etc.

According to various embodiments, the user terminal 200 may include at least one of a smartphone, a tablet personal computer (tablet PC), a mobile phone, a video phone, an e-book reader, a desktop personal computer (desktop PC), a laptop personal computer (laptop PC), a netbook computer, a workstation, a server, a personal digital assistant (PDA), a portable multimedia player (PMP), a camera, or a wearable device.

Referring to FIG. 1, the user terminal 200 may include a processor 210, a communication unit 220, an input unit 230, an output unit 240, and a memory 250 according to various embodiments. According to one embodiment, at least one of the components of the user terminal 200 may be omitted or another component may be additionally provided.

The processor 210 may operate an operating system or application, enabling control over various hardware or software components connected to the processor 210, and perform various data processing and computations. The processor 210 may execute an application by controlling the overall operation of the communication unit 220, the input unit 230, the output unit 240, and the memory 250.

According to various embodiments, the processor 210 may download the chat-channel group-related application from the server 100. The processor 210 may activate a channel group creation interface included in the downloaded application in response to an interaction on the user terminal 200 requesting the creation of a channel group. The processor 210 may request the server 100 to create a channel group based on an interaction from the user account of the user terminal 200 with the channel group creation interface (e.g., channel group name information, participation condition information).

In one embodiment, the chat-channel group-related application may include a chat channel creation interface for creating a chat channel. For example, the processor 210 may download the chat-channel group-related application and activate a chat channel creation interface included in the downloaded application in response to an interaction from the user terminal 200 requesting creation of a chat channel. In another example, a visitor account of another user terminal (visitor terminal) which has signed up for a channel group created by the user account of the user terminal 200 may activate the chat channel creation interface to create a chat channel included in the channel group.

The communication unit 220 may establish communication between the user terminal 200 and an external electronic device. For example, the communication unit 220 may connect to a network via wireless communication or wired communication to communicate with an external electronic device (e.g., external server) or the server 100.

The input unit 230 serves as an interface to transmit a command or data input from a user or another external device to any other component(s) of the user terminal 200. In addition, the input unit 230 may output a command or data received from any other component(s) of the user terminal 200 to a user or another external device. For example, the input unit 230 may include a touchscreen module, a keyboard, a mouse, a button, a camera, a stylus, a microphone, etc.

The user terminal 200 may receive a user's interaction through the input unit 230. An interaction refers to an action of a user operating the input unit to input information into the user terminal 200, reflecting the user's selection or intention. For example, an interaction may include touching a touchscreen, clicking a mouse, typing on a keyboard, inputting sound via a microphone, capturing an image with a camera, recognizing motion with a motion sensor, etc.

The output unit 240 may output various information. The output unit 240 may be a display, a touch screen, a speaker, a vibration generator, a tactile output device, etc. For example, the output unit 240 may provide various contents (e.g., texts, images, videos, animations, icons, or symbols) to a user. According to various embodiments, the output unit 240 may be a device (e.g., Bluetooth earphones) connected to the user terminal 200 via wired or wireless communication (e.g., Bluetooth) to receive and output signals.

The memory 250 functions as a storage medium and can store a number of application programs running on the user terminal 200, data for operating the user terminal 200, and commands. Such memory may be provided in the form of various storage devices such as hardware, ROM, RAM, flash drive, hard drive, etc., or in the form of web storage.

According to various embodiments, the user terminal 200 may include an operating system that controls resources related to the user terminal 200 and/or various applications running on the operating system. For example, the user terminal 200 may include one or more applications that perform functions such as home, dialer, SMS/MMS, browser, camera, and calendar. According to various embodiments, the applications may include an application designated based on the properties of the server 100 or an application received from the server 100. For example, the application may include a preloaded application or a third-party application that can be downloaded from the server 100.

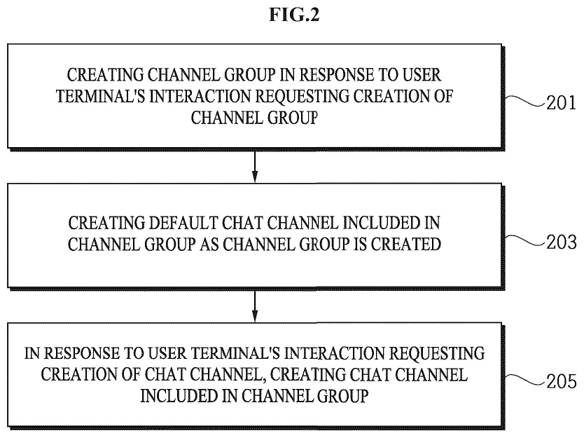

FIG. 2 is a flow chart illustrating an example of a process for providing a channel group including at least one chat channel according to an embodiment of the present disclosure.

According to various embodiments, unless the context clearly indicates a specific order, operations in FIG. 2 may be executed differently from the specified order. That is, the operations may be executed in the same order as specified, may be executed substantially concurrently, or may be executed in a reverse order.

In operation 201, a server 100 may create a channel group in response to an interaction from the user terminal 200 requesting the creation of a channel group. According to various embodiments, the server 100 may provide the user terminal 200 with the chat-channel group-related application including a channel group creation interface. In one embodiment, an external device (e.g., the server 100, an external server channel grouped to the server 100, a third-party server, etc.) may provide a relevant functionality or interface to allow the user terminal 200 to download the chat-channel group-related application that provides chat channels, bulletin boards, content sharing features, etc.

According to various embodiments, when a user account of an electronic device (e.g., the user terminal 200, a third-party electronic device, etc.) that has downloaded the chat-channel group-related application requests to sign up, the server 100 may provide a membership signup interface that requires an ID, a password, identity authentication, etc. After the user account signs up for the chat-channel group-related application, the server 100 may provide a relevant user interface to enable the corresponding user account to log in and manage the account for the chat-channel group-related application.

In yet another embodiment, when a user account of an electronic device (e.g., the user terminal 200, a third-party electronic device, etc.) that has downloaded the chat-channel group-related application requests to sign up, the server 100 may check whether the user account is a member of a second application (e.g., a messenger application, etc.) channel grouped to the chat-channel group-related application. If the user account is a member of an application channel grouped to the chat-channel group-related application, the server 100 may provide a relevant functionality to the user account, which is a member of the chat-channel group-related application, based on the ID and password of the user account, without separately providing a membership signup interface.

In yet another embodiment, even if a user account of an electronic device (e.g., the user terminal 200, a third-party electronic device, etc.) that has downloaded the chat-channel group-related application has not signed up for the chat-channel group-related application, the server 100 may provide access to channel groups (e.g., group links, one-on-one channel groups, open profiles, etc.) created in the chat-channel group-related application. For example, the server 100 may provide a visitor account of the user terminal 200 with access to photos posted in a group link.

According to various embodiments, the server 100 may create multiple channel groups based on an interaction with the channel group creation interface from a user account of the user terminal 200.

According to various embodiments, the channel group creation interface may include information required to create a channel group (e.g., group link, one-on-one channel group, open profile, etc.) by a user account of the user terminal 200. For example, the server 100 may create a channel group based on an input by the user account of user terminal 200 regarding the type of channel group (e.g., group link, one-on-one channel group, open profile, etc.), openness of the channel group (e.g., open channel group, regular channel group), the title of the channel group, and a participation condition (e.g., age, gender limit, etc.).

In one embodiment, the server 100 may create a first channel group based on an interaction with the channel group creation interface regarding the name information and participation condition information of the channel group from a user account of the user terminal 200. For example, the server 100 may create a stock investment club channel group with no participation conditions in response to a request from a user account (petertest@kakao.com) for a ‘Stock Investment Club’ with ‘no participation conditions.’

In one embodiment, the server 100 may create a second channel group based at least partly on an interaction from the user terminal 200 regarding the second channel group with at least different name information from the first channel group. For example, in response to a request from the user account (petertest@kakao.com) to create another channel group based on the ‘Real Estate Investment Club’ and ‘no participation condition’, the server 100 may create the Real Estate Investment Club with no participation condition. As another example, in response to a request from another user account (detsent@kakao.com) to create another channel group based on the ‘Fund Investment Club’ and ‘with a participation condition’, the server 100 may create the Fund Investment Club with a participation condition.

According to various embodiments, the server 100 may create a channel group address corresponding to each channel group. Here, each channel group address may be a link (e.g., Uniform Resource Locator (URL) or a Quick Response (QR) code) containing information that provides connectivity to a corresponding channel group.

For example, the server 100 may assume that accounts (e.g., a user account of the user terminal 200, a third-party account, etc.) signing up for the chat-channel group-related application have created the ‘Stock Investment Club’ channel group with no participation condition, the ‘Real Estate Investment Club’ channel group with no participation condition, and the ‘Fund Investment Club’ channel group with a participation condition. Based on the above assumption, the server 100 may create channel group addresses (e.g., URLs or QR codes) respectively corresponding to ‘Stock Investment Club’ channel group with no participation condition,' ‘Real Estate Investment Club’ channel group with no participation condition, and ‘Fund Investment Club’ channel group with a participation condition.'

According to various embodiments, in response to an interaction from a visitor account requesting participation into a specific channel group, the server 100 may allow participation into the specific channel group and a default chat channel. In one embodiment, the server 100 may simultaneously create the default chat channel included in the specific channel group created by the user account of the user terminal 200. For instance, when the user account of the user terminal 200 creates the ‘Stock Investment’ channel group, the server may simultaneously create a default chat channel that is part of the ‘Stock Investment’ channel group. Here, the default chat channel may be an online chat space that provides a messenger functionality for different user (visitor) accounts.

In another embodiment, the server 100 may choose not to create a default chat channel when a specific channel group is created by the user account of the user terminal 200. For example, when the user account of the user terminal 200 creates the ‘Celebrities’ channel group, the server 100 may create the ‘Celebrities’ channel group alone without creating a channel (e.g., a default chat channel) included in the ‘Celebrities’ channel group.

According to various embodiments, when a visitor account from another electronic device (visitor terminal) requests participation in a channel group, the server 100 may allow participation in the channel group (e.g., Stock Investment channel group, Celebrities channel group) for the visitor account. In one embodiment, when a visitor account from another electronic device has signed up for a channel group, the server 100 may allow participation in a chat channel included in the channel group for the visitor account. Here, participation in the channel group may refer to access to content provided by the channel group, irrespective of whether the visitor account has signed up for the channel group.

Specifically, in response to an interaction input by a visitor terminal 290 inputting a message in a message interface included in the channel group, the server 100 may allow participation in the corresponding chat channel for the visitor account. The interaction from the visitor terminal 290 may involve the visitor account sending a message for one of the default chat channel and chat channels included in the channel group to the server.

The visitor terminal 290 may participate in a chat channel with the visitor account and view the history of messages exchanged in the chat channel. If the visitor account of the visitor terminal 290 inputs a message through the message interface, the server 100 may provide the input message as a reply or comment for the exchanged message history and allow participation in the chat channel for the visitor account at the same time.

Upon approval of membership for the visitor account, the server 100 may provide a relevant functionality or user interface to enable the visitor account to send and receive messages with other user accounts through a messenger functionality.

According to various embodiments, in response to an interaction with one channel among at least one channel from a visitor account of a visitor terminal 290, the server 100 may verify the participation of the user account in the corresponding channel.

According to various embodiments, when the visitor account of the visitor terminal 290 participates in a channel group or a channel included in the channel group, the server 100 may provide a relevant functionality or user interface to select a user profile of the visitor account of the visitor terminal 290. Here, the user profile of the visitor account (e.g., first profile, second profile, third profile, etc.) may be a graphical user interface representing a user account when the user account interacts with a function, content, user interface, or the like provided by an application. For example, each user profile of the visitor account, such as first, second, or third profiles, may be a graphical user interface representing the same visitor account or may be a graphical user interface in which at least one of a text and an image differs.

For example, the visitor account may be Peter (e.g., Peter@kakao.com) has signed up for an application, and the visitor account of Peter may create first, second, and third profiles through a user interface provided by the server 100. In another example, the user profile may include information representing the visitor account of the visitor terminal 290 (e.g., user profile image, name, status message information, contact information, etc.).

According to various embodiments, when the visitor account of the visitor terminal 290 participates in a channel included in a channel group or a channel included in the channel group, the server 100 may allow the visitor account to participate in the channel using a selected user profile. In one embodiment, when a visitor account of the visitor terminal 290 participates in a chat channel, the server 100 may provide a chat interface. Here, the chat interface may provide functionality for sending and receiving messages between different users (visitors) and for providing chat conversation history. For example, when the visitor account of the visitor terminal 290 participates in a chat channel by inputting a message into a message interface, the message input by the visitor account of the visitor terminal 290 may be updated as part of the message sending and receiving history.

According to various embodiments, when the visitor account of the visitor terminal 290 inputs a message requesting to sign up for a chat channel, the server 100 may determine whether the visitor account meets participation conditions for the channel group and chat channel. For example, the server 100 may set participation conditions (e.g., gender, age, password, etc.) that must be met to become a member of a channel group or a channel included in the channel group. In another example, when creating a channel group or after creating a channel group, an operator account may set participation conditions (e.g., gender, age, password, etc.) that must be satisfied.

Here, the participation condition may refer to a predetermined condition for participating in a channel group or a channel included in a channel group as a member and does not refer to a condition for restricting a visitor account from viewing content contained in the channel group and channel. For example, when a participation condition for a chat channel included in a channel group limits participation to individuals born from 1985 to 1990, a visitor account participating in the chat channel may be allowed to view the message history of the chat channel. However, the visitor account may not be allowed to sign up for the chat channel if the visitor account does not meet the participation condition of being born from 1985 to 1990.

In operation 203, the server 100 may create a default chat channel as the channel group is created. In one embodiment, the server 100 may simultaneously create the default chat channel included in the specific channel group created by the user account of the user terminal 200. For instance, when the user account of the user terminal 200 creates the ‘Stock Investment’ channel group, the server may simultaneously create a default chat channel that is part of the ‘Stock Investment’ channel group. Here, the default chat channel may be an online chat space that provides a messenger functionality for different user (visitor) accounts.

In another embodiment, the server 100 may choose not to create a default chat channel when a specific channel group is created by the user account of the user terminal 200. For example, if the user account of the user terminal 200 creates the ‘Stock Investment’ channel group, only the ‘Stock Investment’ channel group is created and a channel (e.g., a default chat channel) included in ‘Celebrities’ channel group may not be created.

In operation 205, a chat channel included in the channel group may be created in response to an interaction from the user terminal 200 requesting the creation of the chat channel.

According to various embodiments, a chat channel creation interface may be activated in response to an interaction from the user terminal 200 requesting the creation of the chat channel. According to one embodiment, after creating the channel group, the user account of the user terminal 200 may activate the chat channel creation interface provided by the channel group. For example, the user account ‘petetrere@kakao.com’ of the user terminal 200 may create a stock investment channel group and activate a chat channel creation interface to be included in the ‘Stock Investment Club.’

According to various embodiments, the user terminal 200 may confirm interactions regarding information necessary for creating a chat channel, such as name information, introduction information, participation conditions, and automatic participation information of the chat channel. The server 100 may create a chat channel based on an interaction from the user account of the user terminal 200. For example, the user account ‘petetrere@kakao.com’ of the user terminal 200 may create a stock investment channel group and a chat channel named ‘20s Stock Investment Club’, included in the ‘Stock Investment Club’, without any participation condition.

According to various embodiments, the server 100 may create multiple chat channels (e.g., a first chat channel, a second chat channel, a third chat channel, etc.) included in a single channel group in response to an interaction from the user terminal 200. For example, the user account ‘petetrere@kakao.com’ of the user terminal 200 may create a stock investment channel group and multiple chat channels (e.g., 20s Stock Investment Club, 30s Stock Investment Club, 40s Stock Investment Club, 50s Stock Investment Club, 60s Stock Investment Club, etc.) included in the stock investment channel group. As another example, the multiple chat channels included in a single channel group may have different names.

According to various embodiments, the server 100 may create chat channel addresses corresponding to the respective chat channels (e.g., the first chat channel, the second chat channel, etc.) included in the channel group. Here, each chat channel address may be a Uniform Resource Locator (URL) or a Quick Response (QR) code containing information providing a connection to a corresponding chat channel.

For example, the server 100 may create a URL like ‘http://openlink.com/patenttest1’ for the ‘20s Stock Investment Club’ chat channel, allowing users of other electronic devices to access the ‘20s Stock Investment Club’ chat channel. As another example, the server 100 may create a different URL, such as ‘http://openlink.com/patenttest2’, for the ‘30s Stock Investment Club’ chat channel, which is different from the URL corresponding to the ‘20s Stock Investment Club’ chat channel, thereby allowing users to access the ‘30s Stock Investment Club’ chat channel. Here, access to a chat channel may mean a participation request by a user (e.g., a visitor account, etc.). If a user account requesting to access a chat channel does not meet a participation condition for the chat channel (e.g., total number of participants in the chat channel, age, membership of a channel group, membership of an application related to the channel group, user account-specific permission set for the channel, etc.), the user account may be restricted from participating in the chat channel.

According to one embodiment, the server 100 may provide a relevant functionality or user interface to allow the user terminal 200 to set, manage, and modify a participation condition for each chat channel included in a channel group. For example, in response to an interaction from the user terminal 200, the server 100 may set a participation condition for the first chat channel among the multiple chat channels included in the channel group, so that the first chat channel is limited to a certain age range (e.g., born between 1985 and 1990), while the second chat channel is limited to a certain gender (e.g., male or female).

According to another embodiment, the server 100 may provide a relevant functionality or user interface to allow the operator account, which created the channel group, to distinctively decide the permissions for members of the channel group and determine each member's participation in each individual channel included in the channel group based on the decided permissions.

For example, the user account ‘petetr@kakao.com’ of the user terminal 200 may create the ‘Real Estate’ channel group, which may include the ‘Seoul Real Estate’ channel, the ‘Gyeonggi Real Estate’ channel, and the ‘Busan Real Estate’ channel. In this example, it may be assumed that first, second, and third user accounts of different user terminals have signed up for the ‘Real Estate’ channel group. In response to an interaction from the operator account ‘petetr@kakao.com’, which created the ‘Real Estate’ channel group, the server 100 may provide a relevant functionality or user interface to grant full access rights across all channels for the first user account of another user terminal. Here, granting full access rights across all the channels may mean allowing the first user account to view the chat history and input chat messages in the ‘Seoul Real Estate’ channel, ‘Gyeonggi Real Estate’ channel, and ‘Busan Real Estate’ channel.

Under this assumption, in response to an interaction from the operator account ‘petetr@kakao.com’, who created the ‘Real Estate’ channel group, the server 100 may allow the second user account, a member of the ‘Real Estate’ channel group, to view the chat history and input chat messages in the ‘Seoul Real Estate’ channel and the ‘Gyeonggi Real Estate’ channel, while only viewing the chat history in the ‘Busan Real Estate’ channel.

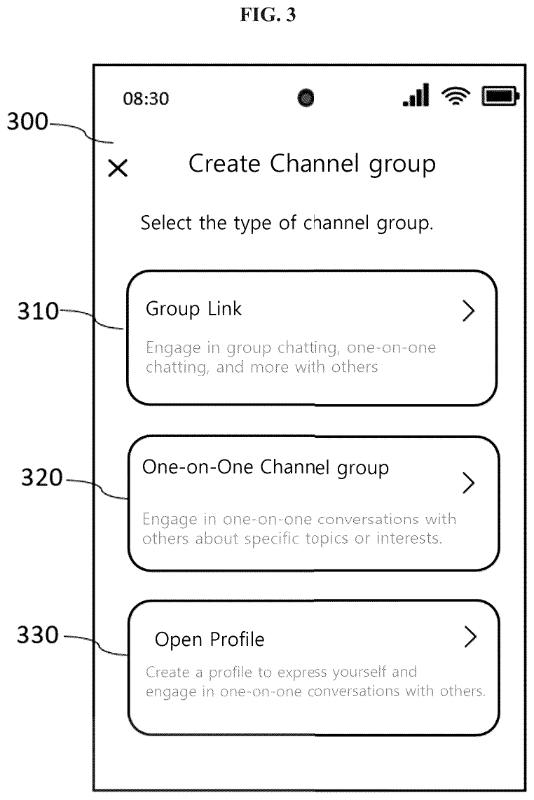

As another example, in response to an interaction from the operator account ‘petetr@kakao.com’, who created the ‘Real Estate’ channel group, the server 100 may now allow the third user account, a member of the ‘Real Estate’ channel group, to input chat messages in the ‘Seoul Real Estate’ channel, the ‘Gyeonggi Real Estate’ channel, and the ‘Busan Real Estate’ channel, but only allow the third user account to view the chat history in these channels. As yet another example, in response to an interaction from the operator account ‘petetr@kakao.com’, who created the ‘Real Estate’ channel group, the server 100 may not allow the third user account, a member of the ‘Real Estate’ channel group, to input chat messages or view the chat history in the ‘Seoul Real Estate’ channel, the ‘Gyeonggi Real Estate’ channel, and the ‘Busan Real Estate’ channel. FIGS. 3 to 5 are diagrams illustrating an example of a user interface for creating a channel group according to an embodiment of the present disclosure.

Referring to FIG. 3, a user terminal 200 may display a channel group creation interface 300 on a screen of the user terminal 200.

According to various embodiments,-channel group-related application may include a plurality of channel groups that provide different functionalities. When creating a channel group through a club creation interface 300, a user account of the user terminal 200 may select one of a group link 310, a one-on-one channel group 320, and an open profile 330 as a type of channel group.

According to various embodiments, the group link 310 may be an online space created on a topic related to users' diverse interests or hobbies. The group link 310 may facilitate sharing information and chatting on various topics such as celebrities, investments (e.g., real estate, US stocks, Korean stocks, etc.), and studying abroad in the US (e.g., language courses, private middle schools, private high schools, etc.) with other user accounts. Additionally, the server 100 may provide a relevant functionality or user interface that allows the user account of the user terminal 200 to create, manage, and modify the group link 310 on various topics.

According to various embodiments, a one-on-one channel group 320 may be a channel group that provides a messenger functionality for different user accounts. For example, the server 100 may provide a relevant functionality or user interface that allows the user account of the user terminal 200 to create a one-on-one channel group and transmit and receive messages with a user account of another electronic device through the created one-on-one channel group.

According to various embodiments, the open profile 330 may refer to a profile representing the user account within the channel group application, such as a graphical user interface corresponding to the user account, when the user account of the user terminal 200 participates in a chat room provided by the chat-channel group-related application or reacts to an uploaded post (e.g., writing comments, liking, etc.).

In one embodiment, the server 100 may provide a relevant functionality or user interface to allow the user account of the user terminal 200 to create an open profile including an image, text, status message, interest tag, etc. For example, if the user account of the user terminal 200 creates an open profile, the server 100 may provide a relevant functionality or user interface to allow the user account to upload a representative image for the open profile or set a name for the open profile. Then, the user account of the user terminal 200 may post a desired text, image, video, etc., through the created open profile and chat with user accounts of other electronic devices.

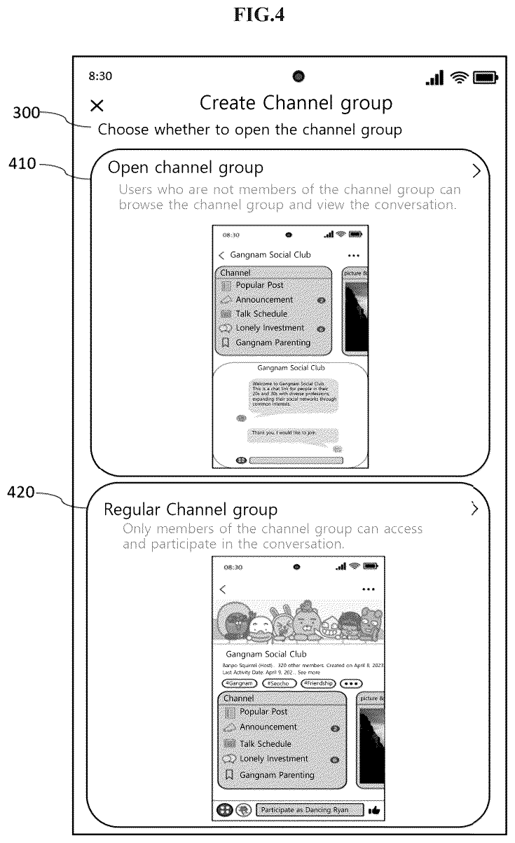

Referring to FIG. 4, a user terminal 200 may display a channel group creation interface 300 on a screen of the user terminal 200.

According to various embodiments, the channel group creation interface 300 based may include a user interface for selecting whether a channel group is open when creating the channel group. In one embodiment, the channel group creation interface 300 may include an open channel group 410 and a regular channel group 420. When creating a channel group through a club creation interface 300, a user account of the user terminal 200 may select the open channel group 410 or the regular channel group 420.

In one embodiment, the open channel group 410 may be a channel group that allows not only members of the channel group but also visitor accounts to view content and information uploaded to the channel group and conversation history among different user accounts. In one embodiment, the regular channel group 420 may be a channel group that allows members of the channel group to view content and information uploaded to the channel group and conversation history among different user accounts while restricting visitor accounts from viewing such content, information, and the like.

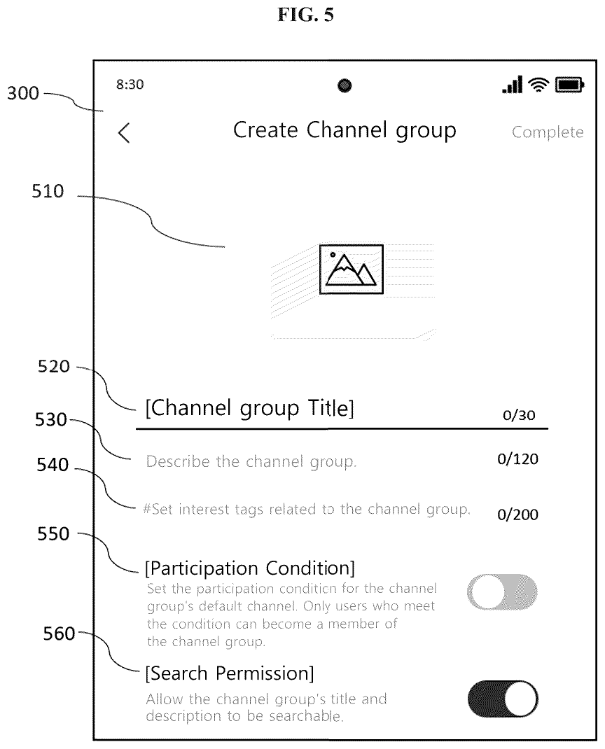

Referring to FIG. 5, a user terminal 200 may display a channel group creation interface 300 on a screen of the user terminal 200.

The channel group creation interface 300 may include a cover image interface 510, a channel group title interface 520, a channel group description interface 530, a tag interface 540, a participation condition interface 550, and a search permission interface 560.

According to various embodiments, the cover image interface 510 may provide an option to select a cover image for a channel group. For example, if a user account of the user terminal 200 inserts a desired image into the image interface 510, the background of the channel group may be set to the inserted image. In one embodiment, the channel group title interface 520 may enable the selection of a title for the channel group. For example, if the user account of the user terminal 200 inputs a desired title such as ‘Gangnam Social Club’ or ‘Stock Investment Club’ into the channel group title interface 520, the title of the channel group may be set to the input title.

According to various embodiments, the channel group description interface 530 may provide a text introducing a channel group. For example, when creating a channel group of ‘Stock Investment Club’ on the user terminal 200, an operational and descriptive text for the channel group (e.g., ‘We share a lot of information here. This group allows open discussion.’) may be set.

According to various embodiments, the tag interface 540, may enable the specification of a keyword (tag) associated with a channel group. For example, the user terminal 200 may set tags such as #investment, #real estate, and #finance for the Stock Investment channel group created by the user account of the user terminal 200. In this case, when a visitor account signs up for the chat-channel group-related application and inputs ‘Investment’ during a channel group search, any channel group containing the keyword ‘Investment’ may be displayed as a search result.

According to various embodiments, the participation condition interface 550 may provide a condition for the channel group. For example, when creating a channel group, the user account of the user terminal 200 may set a condition, such as gender and year of birth, and a visitor account requesting to sign up for the channel group must meet the condition to become a member of the channel group.

According to various embodiments, the search permission interface 560 may provide an option to allow or disallow searching for a channel group. For example, in a case where the user account of the user terminal 200 allows searching for the channel group, the server 100 may provide a search result based on name information, introduction information, etc., of the channel group when the channel group is searched within an application related to the channel group or another application channel grouped to the application.

According to an embodiment, if the user account of the user terminal 200 allows message searching within the channel group, the server 100 may provide a search result based on messages included in the channel group, grouped messages (including an original text message and a reply text message), images, videos, and/or templates. For example, the channel group creation interface 300 may include a user interface for setting whether to allow message searching in a channel group. In the above example, in response to an interaction from the user terminal 200 with the user interface that allows searching for messages (e.g., grouped messages, a keyword contained in chat messages, etc.) within a channel group, the server 100 may provide a search result based on the messages included in the channel group.

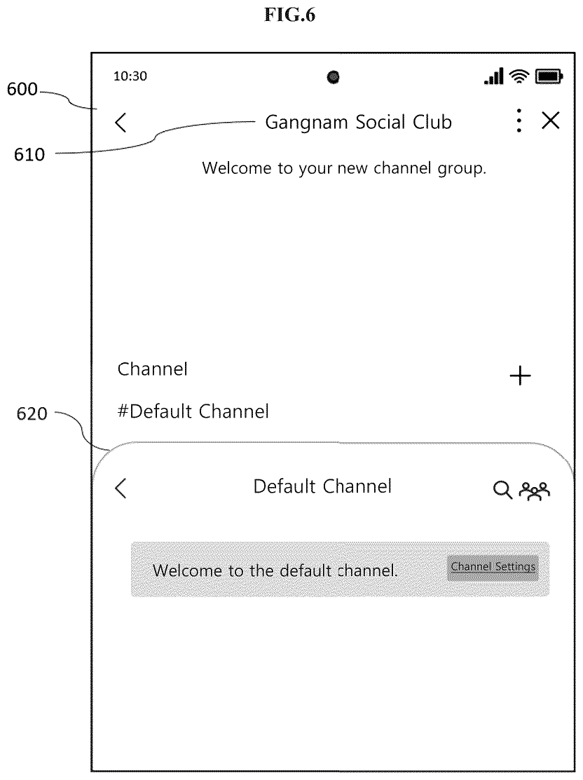

FIG. 6 is a diagram illustrating an example of a user interface in which a channel group has been created according to an embodiment of the present disclosure.

According to various embodiments, on a screen, the user terminal 200 may display a channel group 600 created through a channel group creation interface 300.

According to various embodiments, the channel group 600 may include a channel group title 610 and a default channel interface 620. In one embodiment, the channel group title 610 may be the title of a channel group, which is input by a user account of the user terminal 200. For example, in response to an interaction from the user terminal 200, the server 100 may create a channel group with the title ‘Gangnam Social Club.’

According to various embodiments, the channel group 600 may include the default channel interface 620. In one embodiment, the default channel interface 620 may be a channel created upon the creation of the channel group 600. For example, the default channel interface 620 may provide a related functionality or interface for checking and modifying settings regarding channel information and channel management. As another example, the default channel interface 620 may be an interface provided only to the user account of the user terminal 200 that created the channel group.

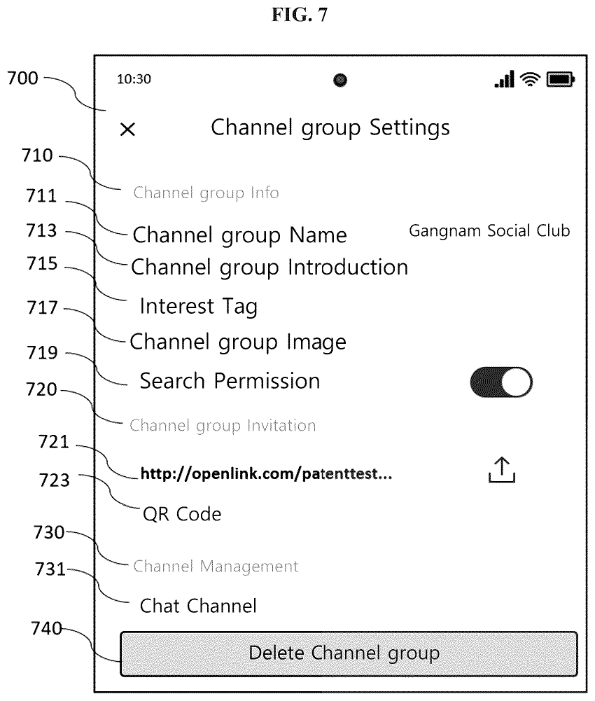

FIGS. 7 to 9 are diagrams each illustrating an example of a user interface for creating a chat channel included in a channel group according to an embodiment of the present disclosure.

Referring to FIG. 7, a user terminal 200 may display a channel group setting interface 700 on a screen of the user terminal 200.

The channel group setting interface 700 may include a channel group information interface 710, a channel group invitation interface 720, a channel management interface 730, and a channel group deletion interface 740.

According to various embodiments, the channel group information interface 710 may include channel group name information 711, channel group introduction information 713, interest tag information 715, channel group image information 717, and search permission setting information 719. In one embodiment, the channel group name information 711 may include the name of the channel group.

For example, if the name of the channel group is ‘Gangnam Social Club,’ the user terminal 200 may display ‘Gangnam Social Club’ in a region corresponding to the channel group name on the screen of the user terminal 200. In one embodiment, the channel group introduction information 713, the interest tag information 715, the channel group image 717, and the search permission setting information 719 may be set based on information input by the user account of the user terminal 200 through the channel group creation interface 300, as disclosed in FIG. 5. The user account of the user terminal 200 may check and modify each pre-setting of the channel group in response to any interaction with the channel group introduction information 713, the interest tag information 715, the channel group image 717, and the search permission setting information 719.

According to various embodiments, the channel group invitation interface 720 may include channel group address information 721 and QR code information 723. The channel group address information 721 may be a Uniform Resource Locator (URL) corresponding to the created channel group. The QR code information 723 may be a two-dimensional code in matrix format, which represents information using a black-and-white grid pattern. In one embodiment, the channel group address information 721 and/or QR code information 723 may be automatically created upon the creation of the channel group. Once the channel group address information 721 and/or QR code information 723 is created, any modification and change by the user terminal 200 or the server 100 may not be allowed. In another embodiment, the channel group address information 721 and/or QR code information 723 may be automatically created upon the creation of the channel group and may be updated by the user terminal 200 or the server 100.

According to various embodiments, the server 100 may manage specific channel group address information 721 and/or QR code information 723. In one embodiment, based on URL preference information, title information of a URL, etc., the server 100 may set a specific URL address as a paid URL address. For example, when the user account of the user terminal 200 creates the ‘Investment’ channel group, a URL containing ‘Invest’ or ‘Investment’ is expected to have high user preference, so the server 100 may set such a URL as a paid URL. In the above example, when the user terminal 200 creates the ‘Investment’ channel group, the server 100 may provide a relevant functionality or user interface so that a pop-up window querying whether to select channel group address information 721 containing a paid URL (e.g., a URL containing ‘Invest,’ ‘Investment’, etc.) is displayed on the screen of the user terminal 200.

According to various embodiments, if the user terminal 200 selects a paid URL, the server 100 may provide a relevant functionality or user interface required for payment (e.g., a credit card payment window including input fields for credit card number, expiration date, CVV, etc., and a payment method including a credit card, a debit card, an electronic wallet, etc.). If the user terminal 200 selects a paid URL when creating a channel group, the server 100 may assign the paid URL selected by the user terminal 200 to the channel group. Alternatively, if the user terminal 200 does not select the paid URL when creating a channel group, the server 100 may assign a random URL.

According to various embodiments, the channel management interface 730 may include a chat channel interface 731 included in the channel group. The chat channel interface 731 may facilitate creating and modifying a chat channel included in the channel group. According to various embodiments, the channel group setting interface 700 may include the channel group deletion interface 740. The channel group deletion interface 740 may provide the functionality to delete a channel group.

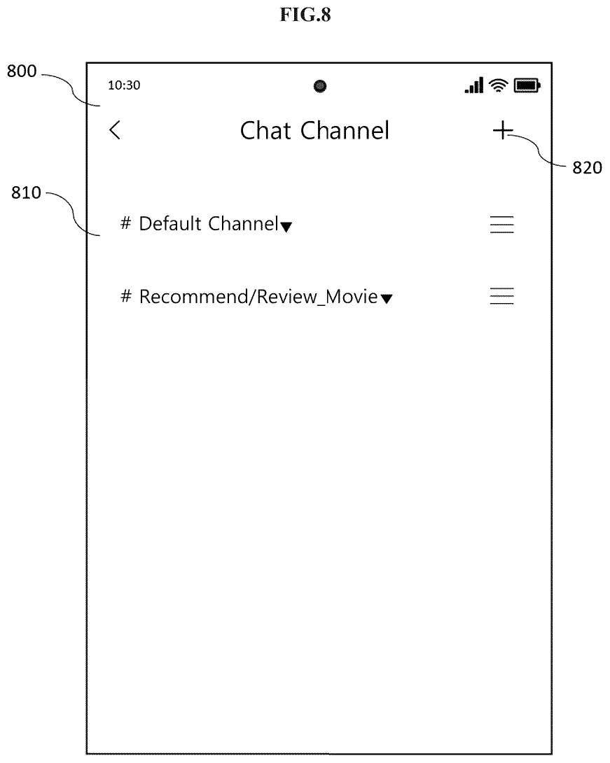

Referring to FIG. 8, a user terminal 200 may display on a screen a chat channel list interface 800 that is activated when a user of the user terminal 200 interacts with a chat channel interface 731 of the user terminal 200.

According to various embodiments, the chat channel list interface 800 may include channel list information 810 included in a channel group 600, and a chat channel addition interface 820. For example, the channel list information 810 may include channels such as ‘Default Channel’ and ‘Recommend/Review_Movie’ included in the channel group 600. When an interaction from the user terminal 200 with the chat channel addition interface 820 is detected, the server 100 may provide a chat channel creation interface for creating a new chat channel.

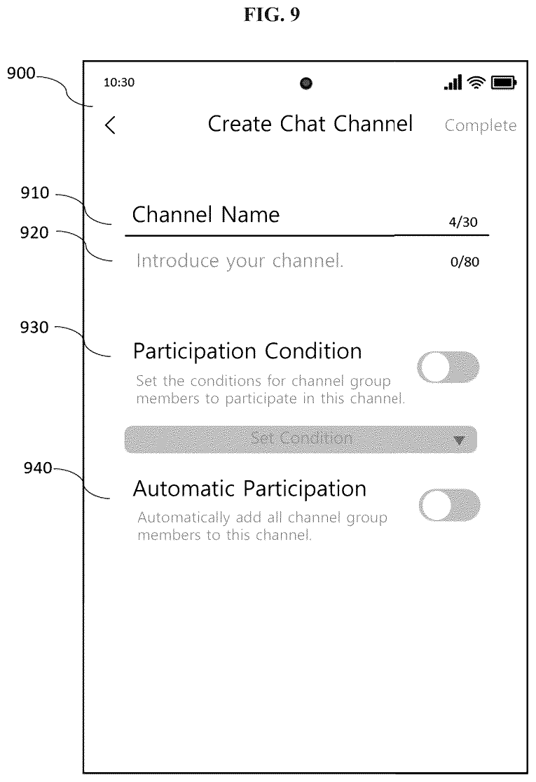

Referring to FIG. 9, a user terminal 200 displays a chat channel creation interface 900 on a screen thereof, the interface 900 which is activated in response to an interaction from the user terminal 200 with a chat channel addition interface 820.

The chat channel creation interface 900 may include a chat channel name interface 910, a channel introduction interface 920, a participation condition setting interface 930, and an automatic participation interface 940.

According to various embodiments, the chat channel name interface 910 may enable selection of a name for a chat channel. For example, when a user account of the user terminal 200 inputs a desired title such as ‘20s Stock Investment Club’ in the chat channel name interface 910, the input title may be set as the name of the chat channel.

According to various embodiments, the channel introduction interface 920 may provide a text introducing a chat channel. For example, when the user terminal 200 creates a chat channel for ‘20s Stock Investment Club,’ a text introducing the chat channel (e.g., “Let's talk about both domestic and foreign stock markets”) may be set.

According to various embodiments, the participation condition setting interface 930 may provide a functionality to set a condition for a user account to participate in a channel group's channel. For example, when creating a channel group, the user account of the user terminal 200 may set a condition such as gender, birth year, etc., and a visitor account requesting to sign up for a chat channel must meet these conditions to become a member of the chat channel.

According to various embodiments, the automatic participation interface 940 may provide a functionality to set a visitor account to automatically participate in a chat channel when the visitor account of another electronic device participates in the channel group as a member. For example, the server 100 set a visitor account to automatically participate in the ‘20's Stock Investment Club’ included in the ‘Stock Investment’ channel group based on the settings of the automatic participation interface 940 when the visitor account participates in the ‘Stock Investment’ channel group as a member.

According to one embodiment, the server 100 may limit the number of channels in which a visitor account from another electronic device can automatically participate when participating in a chat channel as a member. For example, the server 100 may limit the number of chat channels available for automatic participation to five when the user terminal 200 creates a ‘Stock’ channel group and a visitor account joins the ‘Stock’ channel group.

According to an embodiment, when the user account of the user terminal 200 meets a participation condition of a channel group 600 and is approved as a member, the server 100 may approve the user account to participate in all channels included in the channel group 600 (e.g., Popular Posts channel, Announcement channel, Talk Schedule channel, Lonely Investment chat channel, and Gangnam Parenting chat channel). For example, based on a message received from the user terminal 200, the server 100 may determine whether the user account of the user terminal 200 meets the participation condition for the channel group 600. In such an example, if the user account of the user terminal 200 meets the participation conditions for the channel group 600, the server 100 may allow the user account to participate in the channel group 600 and all the channels included in the channel group 600. Here, the participation in the channel group 600 and all the channels included in the channel group 600 may mean that the user account of the user terminal 200 participates as a member of the channel group 600 and all the channels included in the channel group 600.

According to another embodiment, in response to receiving a message input within a channel (e.g., Lonely Investment chat channel) by the user terminal 200, the server 100 may check the eligibility of the user account to participate in all the channels included in the channel group 600 (e.g., Popular Posts channel, Announcement channel, Talk Schedule channel, Lonely Investment chat channel, and Gangnam Parenting chat channel). In one embodiment, participation conditions (e.g., gender, age, password, etc.) and maximum participant limits may be set differently for the respective channels included in channel group 600. For example, the maximum participant limit for the ‘Announcement’ channel, which is one of the channels included in the channel group 600, may be set to 100, whereas the maximum participant limit for the ‘Gangnam Parenting’ chat channel may be set to 200.

In such an example, if the user account of the user terminal 200 does not meet a participation condition (e.g., gender, age, password, etc.) for a channel included in the channel group 600, or if the channel has already reached the maximum participant limit, the server 100 may exclude participation in the corresponding channel. For example, in response to receiving a message input to the ‘Lonely Investment’ chat channel by the user terminal 200, the server 100 may check the participation condition and/or the maximum participant limit for the ‘Lonely Investment’ chat channel.

In another example, if the user account of the user terminal 200 is male and the participation condition for the ‘Gangnam Parenting’ chat channel is female, the user account of the user terminal 200 may be excluded from participating in the ‘Gangnam Parenting’ chat channel. In yet another example, if a maximum participant limit for the Announcement channel is set to 100 and has already been reached, the server 100 may exclude the user account from participating in the Announcement channel when receiving a message input to the ‘Lonely Investment’ chat channel by the user terminal 200.

Thereafter, when the server 100 receives an individual participation request from the user terminal 200 for the excluded channels (e.g., Gangnam Parenting chat channel, Announcement channel, etc.), the server 100 may determine whether to allow the user account of the user terminal 200 to participate in the excluded channels. According to one embodiment, the participation condition and maximum participant limit for each channel included in the channel group 600 may be modified by an operator account that created a corresponding channel or by the server 100. According to another embodiment, while the maximum participant limit for a channel is maintained, the number of user accounts joining and leaving the channel may fluctuate. In this case, at a particular time, the maximum participant limit for the channel may be reached so the user account of the user terminal 200 may not be allowed to participate in the channel. However, participation may be allowed at a later time.

For example, when receiving a message input to the ‘Lonely InvestmentI’ chat channel included in the channel group 600 by the user terminal 200, the server 100 may allow participation in all channels (e.g., Talk Schedule channel, Lonely Investment chat channel) except for the Gangnam Parenting chat channel and the Announcement channel, which fail to meet the participation conditions and/or have already reached the maximum participant limits. In such an example, if the maximum participant limit for the ‘Announcement’ channel is 100, this limit may have already been reached at a time of receiving the message from the user terminal 200, so the server 100 may exclude the user account of the user terminal 200 from participating in the ‘Announcement’ channel.

Thereafter, if some user accounts withdraw from the ‘Announcement’ channel and the user terminal 200 requests individual participation in the ‘Announcement’ channel, the server 100 may allow the user account of the user terminal 200 to participate in the ‘Announcement’ channel. When the user terminal 200 participates in the ‘Announcement’ channel as a member, a pop-up notification such as ‘Joined as a channel member’ may be displayed in a region of the screen of the user terminal 200.

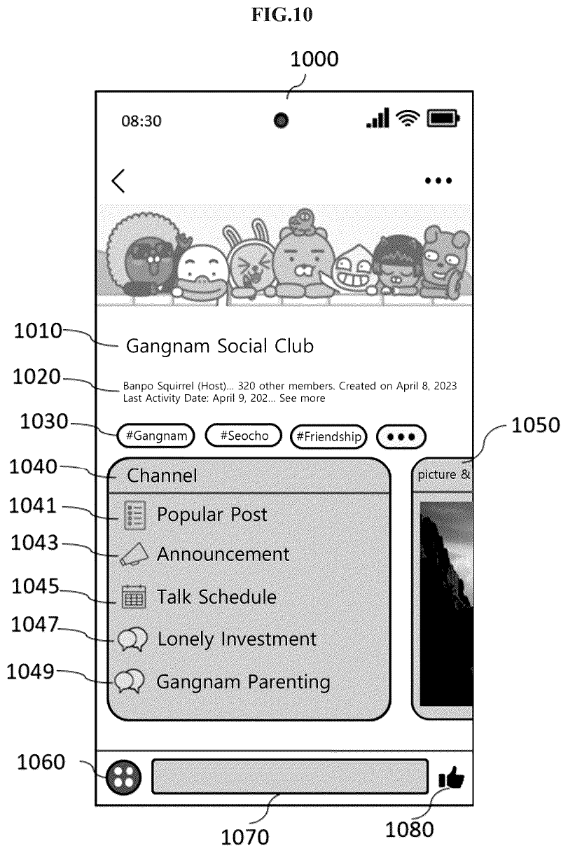

FIGS. 10 to 12 illustrate examples of a group link, a one-to-one channel group, and an open profile user interface created by a channel group user interface according to an embodiment of the present disclosure.

Referring to FIG. 10, a server 100 may provide a channel group 1000 (e.g., a group link). According to various embodiments, the channel group 1000 may include a channel group name interface 1010, a channel group information interface 1020, a channel group hashtag interface 1030, a channel interface 1040, a content interface 1050, an additional feature interface 1060, a message writing interface 1070, and a like interface 1080. Some of the interfaces included in the channel group 1000 may be omitted or added, and are not limited to the configurations disclosed in FIG. 10.

According to various embodiments, the channel group name interface 1010 may include a text regarding a name, topic, and the like of a channel group. The server 100 may provide a user interface for creating a channel group, and a user account may set the name of the channel group. For example, the server 100 may display the topic of the channel group, ‘Gangnam Social Club’, on a screen of the user terminal 200.

According to various embodiments, the channel group information interface 1020 may include information on an operator account (e.g., Banpo Squirrel) that created the channel group, information on the number of members signed up for the channel group (e.g., 320 members), information on the date of creation of the channel group (e.g., Apr. 8, 2023), and information on last activities of the members of the channel group (e.g., last activity date: Apr. 9, 2023). According to various embodiments, the channel group hashtag interface 1030 may include hashtags (e.g., #Gangnam, #Seocho, #Friendship, etc.) used to channel group related content on a social networking service or microblogging service when an operator account creates a channel group.

According to various embodiments, the channel interface 1040 may include various channels provided in the channel group (e.g., ‘Popular Post’ channel 1041, ‘Announcement’ channel 1043, Talk Schedule channel 1045, a chat channel 1047, (e.g., Lonely Investment), a second chat channel 1049 (e.g., Gangnam Parenting)). The content interface 1050 may include an image and video provided in the channel group. The additional feature interface 1060 may provide various features or graphic user interfaces regarding images, videos, and the like which are necessary for chatting between different user accounts in a chat channel included in the channel group 1000.

According to various embodiments, the message writing interface 1070 may include an input interface where a user account visiting or signing up for the channel group can write a message. According to various embodiments, the like interface 1080 may be an interface where a user account visiting or signing up for the channel group 1000 can interact (e.g., like) with a specific channel included in the channel group. For example, if a user account's profile interacts with the like interface 1080 regarding a post provided in a specific channel of the channel group 1000 is confirmed, the server 100 may store the interaction in a memory 120.

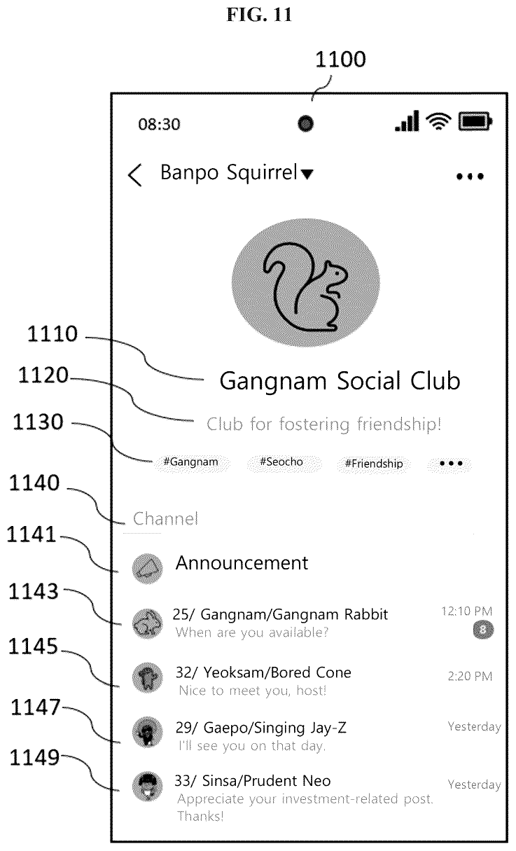

Referring to FIG. 11, a server 100 may provide a channel group 1100 (e.g., a one-to-one channel group). According to various embodiments, the channel group 1100 may include a channel group name interface 1110, a channel group description interface 1120, a channel group hashtag interface 1130, and a channel interface 1140. Some interfaces included in the channel group 1100 may be omitted or added, and are not limited to the configurations disclosed in FIG. 11.

According to various embodiments, the channel group name interface 1110 may include a text regarding a topic of the channel group 1100. The server 100 may provide a user interface for creating the channel group 1100, and a user account may set the topic of the channel group 1100. For example, the server 100 may provide the channel group name interface 1110 to display the topic of the channel group 1100, ‘Gangnam Friendship Gathering,’ on a screen of the user terminal 200.

According to various embodiments, the channel group description interface 1120 may include a text describing additional information about the channel group 1100. For example, the server 100 may provide the channel group description interface 1120 to describe the channel group 1100 as a ‘Club for fostering friendship!’ on the screen. According to various embodiments, the channel group hashtag interface 1130 may include hashtags (e.g., #Gangnam, #Seocho, #Friendship, etc.) used to channel group related content on a social networking service or microblogging service when an operator account (e.g., Banpo Squirrel) creates a channel group.

According to various embodiments, the channel interface 1140 may include an ‘Announcement’ channel 1141 and one-on-one chat channels 1143, 1145, 1147, and 1149 between different user accounts. In one embodiment, the ‘Announcement’ channel 1141 may be created by an operator account (e.g., Banpo Squirrel), who created the channel group 1100, or may be automatically created by the server 100 when the channel group 1100 is created. Here, the one-on-one chat channels 1143, 1145, 1147, and 1149 may include a functionality for exchanging messages between different user accounts who have signed up for the same channel group. For example, the operator account ‘Banpo Squirrel’ of the channel group 1100 may exchange messages through the one-on-one chat channels 1143, 1145, 1147, and 1149 with user accounts of other electronic devices (e.g., a visitor account, another account signed up for the channel group 1100, etc.).

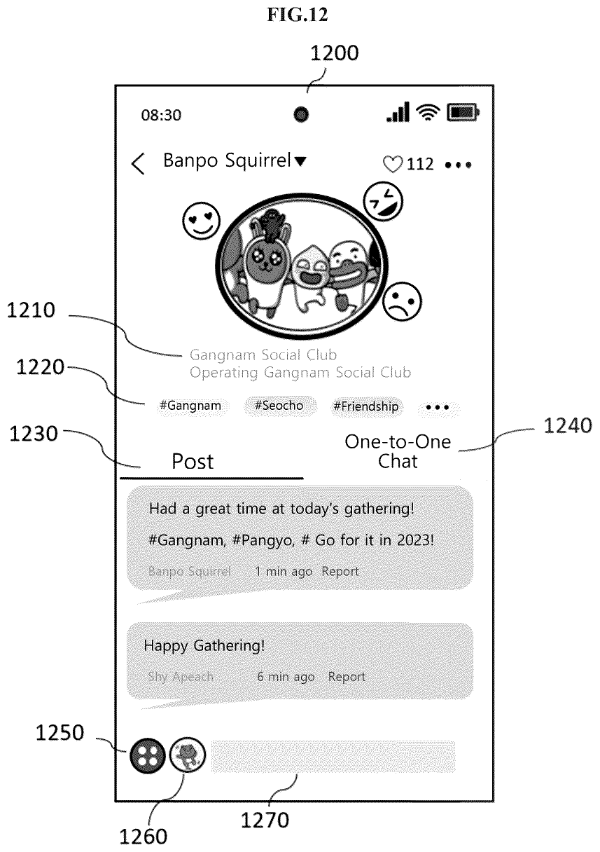

Referring to FIG. 12, a server 100 may provide an open profile 1200, which is a channel group. According to various embodiments, the open profile 1200 may include an open profile name interface 1210, an open profile hashtag interface 1220, Post 1230, a one-on-one chat interface 1240, an additional feature interface 1250, a profile setting interface 1260, and a message writing interface 1270.

According to various embodiments, the open profile description interface 1210 may include a text describing additional information about the open profile 1200. For example, the server 100 may provide the open profile description interface 1210 to display ‘Operating Gangnam Social Club’ on the screen. According to various embodiments, the open profile hashtag interface 1220 may include hashtags (e.g., #Gangnam, #Seocho, #Friendship, etc.) used to channel group related content on a social networking service or microblogging service when the operator account (e.g., Banpo Squirrel) creates the open profile 1200.

According to various embodiments, the Post 1230 created by the operator account (e.g., Banpo Squirrel) or other user accounts (e.g., a visitor account, another user account signed up for the channel group, etc.) may include information such as text, images, videos, hashtags, posting date, and polling messages. According to various embodiments, the one-on-one chat interface 1240 may provide a messenger functionality for the operator account (e.g., Banpo Squirrel) and any other user account (e.g., a visitor account, another user account signed up for the channel group, etc.).

According to various embodiments, the additional feature interface 1250 may provide various features or graphic user interfaces regarding images, videos and the like which are necessary for chatting between different user accounts in a chat channel included in the channel group 1000.

According to various embodiments, the profile setting interface 1260 may include information about a current profile in use and any unused profile for a user account visiting or signing up for the current channel group. In one embodiment, upon detecting a user interaction with the profile setting interface 1260, the user terminal 200 may provide profiles that the user account can choose from. For example, when a touch interaction with the profile setting interface 1260 is detected, the user terminal 200 may display profiles such as ‘Hungry Chunsik,’ ‘Dancing Ryan,’ ‘Muzi,’ and ‘Shy Apeach’ on the screen. According to various embodiments,, the message writing interface 1270 may include an input interface that allows a user account visiting or signing up for the channel group to write a message.

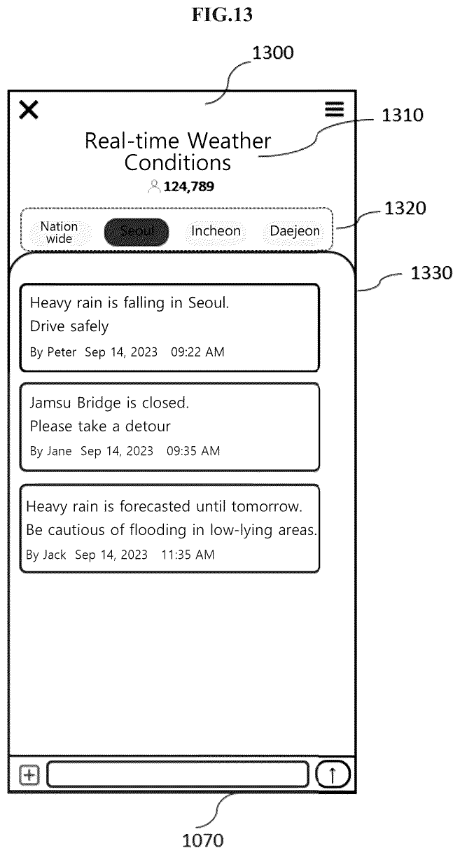

FIG. 13 is a diagram illustrating an example of a group link user interface according to an embodiment of the present disclosure.

According to various embodiments, a server 100 may provide a channel group 1300 (e.g., a group link). In one embodiment, the channel group 1300 may include a channel group name interface 1310, a channel interface 1320, and a chat room interface 1330. Some interfaces included in the channel group 1300 may be omitted or added, and are not limited to the configurations disclosed in FIG. 13.

According to various embodiments, the channel group name interface 1310 may include a text regarding a name, topic, and the like of the channel group 1300. The server 100 may provide a user interface to create the channel group 1300, and a user account may set the name of the channel group 1300. For example, the server 100 may display the topic ‘Real-time Weather Conditions’ of the channel group 1300 through the channel group name interface 1310 on the screen of the user terminal 200. In another embodiment, the server 100 may provide a functionality to create the channel group 1300 named ‘Real-time Weather Conditions’ by an operator of the server 100, without any interaction from the user terminal 200.

According to various embodiments, the channel interface 1320 may include various channels provided in the channel group 1300 (e.g., Nationwide channel, Seoul channel, Incheon channel, Daejeon channel, etc.). In one embodiment, the channels included in the channel group 1300 may be created, modified, and deleted by an operator account of the server 100 or by the user terminal 200 that created the channel group 1300.

According to various embodiments, the chat room interface 1300 may include a chat room corresponding to each channel included in the channel group 1300. When the user terminal 200 detects an interaction with the ‘Seoul’ channel in the channel interface 1320, the user terminal 200 may display a chat room corresponding to the ‘Seoul’ channel in a region of the screen of the user terminal 200. Here, a chat room corresponding to each channel (e.g., chat room of the ‘Seoul’ channel) may include chat history of different user accounts. For example, the chat room interface 1330 may include chat history of different user accounts, such as ‘Heavy rain is falling in Seoul. Drive safely,’ ‘Jamsu Bridge is closed. Please take a detour,’ and ‘Heavy rain is forecasted until tomorrow. Be cautious of flooding in low-lying areas.’

In one embodiment, while participating in the ‘Seoul channel,’ the user terminal 200 may receive a chat message input through the message writing interface 1070. The user terminal 200 may transmit the input chat message to the server 100, and the server 100 may provide a functionality to display the chat message input by the user terminal 200 in the chat room interface 1330 of the ‘Seoul’ channel. For example, when the user terminal 200 inputs a chat message through the message writing interface 1070, the user terminal 200 may display the chat message in a region of the chat room interface 1330 of the ‘Seoul’ channel.

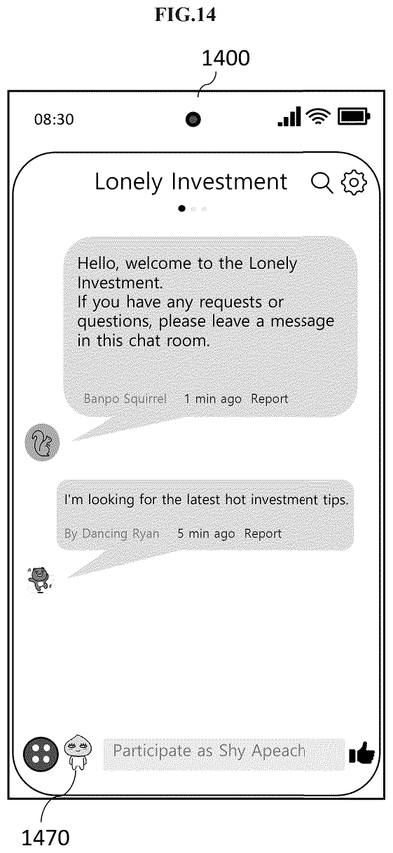

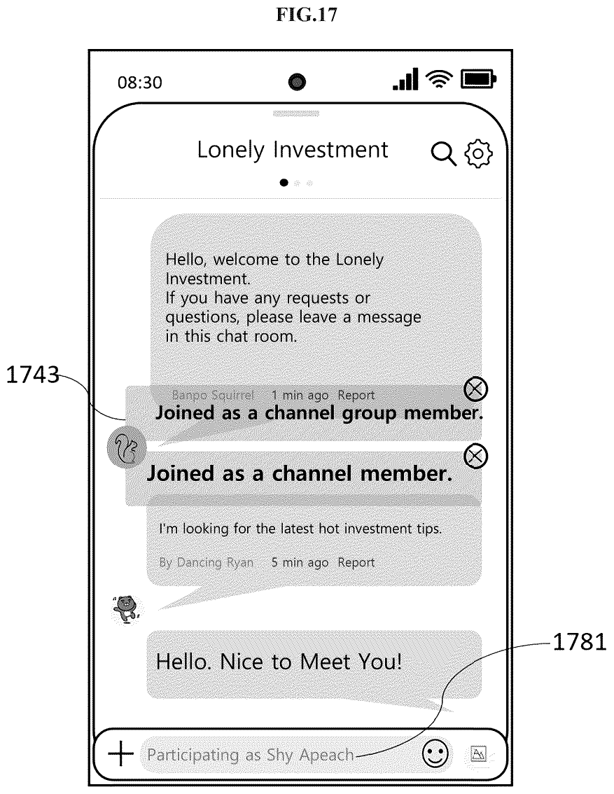

FIGS. 14 to 17 are diagrams illustrating an example in which a visitor terminal 290 participates in a channel included in a channel group according to an embodiment of the present disclosure.

Referring to FIG. 14, even if a visitor account of the visitor terminal 290 has not signed up for the channel group 1400 and the ‘Lonely Investment’ chat channel, the server 100 may provide the chat history of the ‘Lonely Investment’ chat channel. For example, the chat history may include a message input by another user account ‘Banpo Squirrel’ (e.g., ‘Hello, welcome to the Lonely Investment. If you have any requests or questions, please leave a message in this chat room’), and a message input by another user account, ‘Dancing Ryan’ (e.g., ‘I'm looking for the latest hot investment tips’).

According to various embodiments, a user profile interface 1470 may include a profile of a visitor account visiting or signing up for the current channel group 1400. For example, the user profile interface 1470 may include a default profile preset by the server 100 or a profile set by the visitor account upon signing up for the channel group. In one embodiment, if the server 100 detects a user interaction with the user profile interface 1470, the server 100 may provide a relevant user interface for the visitor account to set and change the profile.

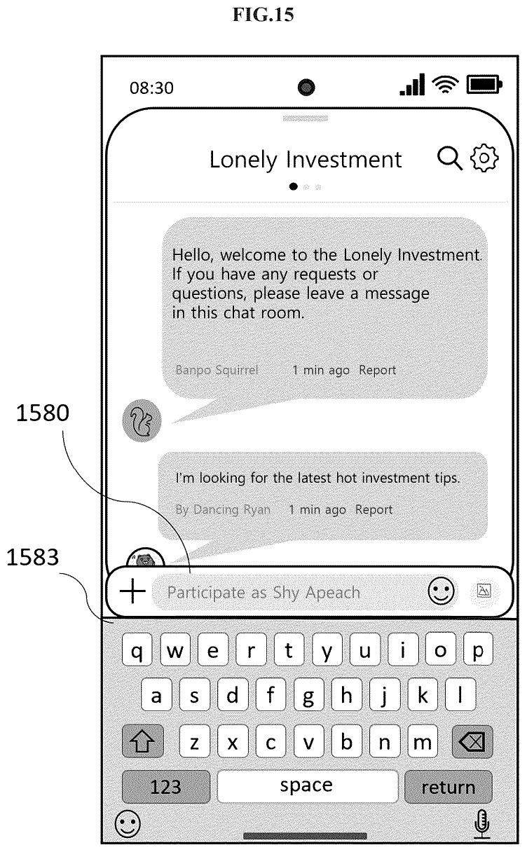

Referring to FIG. 15, if an interaction from the visitor terminal 290 with a message interface 1580 is detected, the server 100 may activate a message input interface 1583. For example, a visitor terminal 290 may display the activated message input interface 1583 in a region of a screen of the visitor terminal 290 (e.g., at the bottom or top of the screen). The message input interface 1583 may include a keyboard allowing the visitor terminal 290 to input text, images, videos, etc., in Korean, English alphabet, emoticons, etc.

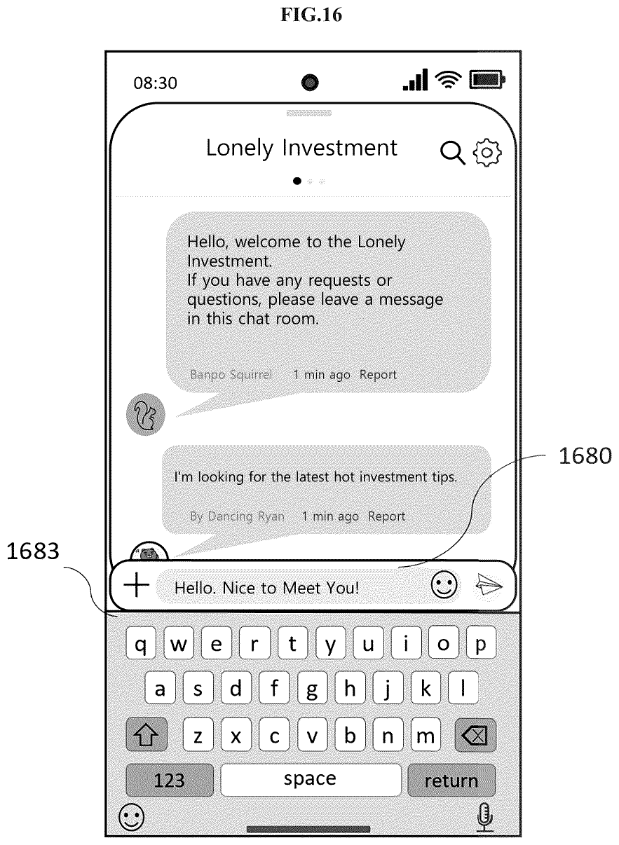

Referring to FIG. 16, a visitor terminal 290 may confirm an interaction to enter a message (e.g., ‘Hello. Nice to meet you!’) through a message input interface 1683.

According to various embodiments, the visitor terminal 290 may check a messages input by the visitor account and transmit the message to the server 100. For example, the visitor terminal 290 may display the input text, emoticon, or the like on a message interface 1680 and, in response to an interaction from the visitor account with a message send button, transmit the input text, emoticon, or the like to the server 100.

According to various embodiments, upon receiving a message input by the visitor terminal 290, the server 100 may determine whether the visitor account meets a participation condition for a channel group and the ‘Lonely Investment’ chat channel included in the channel group.

In one embodiment, if the visitor account of the visitor terminal 290 meets the participation condition for the channel group and the ‘Lonely Investment’ chat channel, the visitor terminal 290 may display a notice interface 1743 in a region of a screen of the visitor terminal 290. For example, the visitor terminal 290 may display a pop-up notification such as ‘Joined as a channel group member’ and ‘Joined as a channel member’ in a region of the screen of the visitor terminal 290. In one embodiment, as the visitor account of the visitor terminal 290 is participating in the ‘Lonely Investment’ chat channel as a member, the visitor terminal 290 may modify user profile information 1781 to read ‘Currently participating as Shy Apeach’ from ‘Currently participating as Shy Apeach’.

In one embodiment, when the visitor account of the visitor terminal 290 meets the participation condition for the channel group and is approved to join the channel group as a member, the server 100 may authorize the visitor account as a member for all channels included in the channel group.

For example, upon receiving a message input by the visitor terminal 290, the server 100 may determine whether the visitor account of the visitor terminal 290 meets the participation condition for the channel group. In such an example, if the visitor account of the visitor terminal 290 meets the participation condition for the channel group, the server 100 may allow the visitor account to participate in the channel group and all channels included in the channel group. Here, the participation in the channel group and all channels included in the channel group may mean that the visitor account of the visitor terminal 290 participates in the channel group and all the channels included in the channel group as a member.

In another embodiment, upon receiving a message input by the visitor terminal 290 in the ‘Lonely Investment’ chat channel, the server 100 may check the eligibility of the visitor account to participate in all channels included in the channel group. In one embodiment, the participation condition (e.g., gender, age, password, etc.) and maximum participant limit for each individual channel included in the channel group may be set. For example, an ‘Announcement’ channel in the channel group may have a maximum participant limit of 100.

In the example above, if the visitor account of the visitor terminal 290 does not meet the participation condition (e.g., gender, age, password, etc.) for the channel group included in the channel, or if the channel has already reached the maximum participant limit, the server 100 may exclude the visitor account from participating in the channel.

For example, upon receiving a message input the visitor terminal 290 in the ‘Lonely Investment’ chat channel, the server 100 may allow the visitor account to participate in all channels except channels of which the participation conditions are not met and/or the maximum participant limits are already reached.

In yet another embodiment, upon receiving a message input by the visitor terminal 290, the server 100 may determine whether a participation condition (e.g., gender, age, password, etc.) for a default channel (e.g., a default chat channel) included in the channel group is met.

According to an embodiment of the present disclosure, a user account may create a channel group that provides various functionalities, including messaging and content sharing, facilitating efficient information exchange and communication with other user accounts.

According to one embodiment of the present disclosure, a user account of a user terminal may create multiple channel groups and various channels included in each channel group, enabling structured organization of diverse and extensive information and efficient implementation and management of functions.

According to various embodiments of the present disclosure, at least some of the devices (for example, modules or functions thereof) or the methods may be implemented by instructions stored in a computer-readable storage medium in a programming module form. When executed by a processor (e.g., the processor 110, the processor 210, etc.), an instruction may cause one or more processors to perform a function corresponding to the instruction. For example, the computer-readable storage medium may be a memory (e.g., the memory 120, the memory 250, etc.).

The technical features disclosed in each embodiment of the present disclosure are not limited to a corresponding embodiment, and unless incompatible with each other, the technical features disclosed in each embodiment may be applied in combination to different embodiments.

Therefore, although each embodiment is described mainly about an individual technical feature, the technical features of the embodiments of the present disclosure may be applied in combination unless they are incompatible with each other.

The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.

What is claimed is:

1. A method for providing at least one channel group by a server, the method comprising:
in response to an interaction from a user terminal requesting creation of a channel group, creating the channel group;
in response to the channel group being created, creating a default chat channel included in the channel group; and
in response to an interaction from the user terminal requesting creation of a chat channel, creating the chat channel included in the channel group.

2. The method of claim 1, wherein creating the chat channel comprises:
creating a first chat channel included in the channel group, based at least partly on an interaction from the user terminal; and
creating a second chat channel included in the channel group, based at least partly on an interaction from the user terminal.

3. The method of claim 2, further comprising:
creating a channel group address corresponding to the channel group;
creating a first chat channel address corresponding to the first chat channel; and
creating a second chat channel address corresponding to the second chat channel.

4. The method of claim 1, wherein creating the channel group comprises creating at least one of the following: a group link for sharing at least one content and engaging in a group chat with a plurality of user accounts, a one-to-one channel group for engaging in a one-to-one chat with a different user account, or an open profile representing a user account of the user terminal on the channel group.

5. The method of claim 1, wherein creating the channel group comprises:
creating the first channel group based at least partly on an interaction from the user terminal; and
creating the second channel group based at least partly on an interaction of the user terminal.

6. The method of claim 5, further comprising:
creating a first channel group address corresponding to the first channel group; and
creating a second channel group address corresponding to the second channel group.

7. The method of claim 1, further comprising:
in response to an interaction from a visitor account requesting participation in the channel group, allowing participation of the visitor account in the channel group and the default chat channel.

8. The method of claim 7, wherein the interaction from the visitor account is an interaction of inputting a message for one of the default chat channel and the chat channel included in the channel group.

9. The method of claim 8, wherein:
the interaction from the visitor account comprises an interaction of selecting a user profile of the visitor account, and
in allowing the participation in the channel group and the default chat channel, the server allows participation in the channel group and in the default chat channel using the selected user profile.

10. The method of claim 1, further comprising, in response to an interaction from a visitor terminal transmitting a message for one of the default chat channel and the chat channel included in the channel group to the server, identifying participation of the visitor terminal in a corresponding channel as a member.

11. The method of claim 10, wherein identifying the participation of the visitor terminal comprises:
identifying whether the visitor terminal is a member of the channel group; and
identifying whether the visitor terminal is a member of the chat channel.

12. A server providing at least one channel group, the server comprising:
a memory storing instructions, and
a processor configured to execute the instructions to:
in response to an interaction from a user terminal requesting creation of a channel group, create the channel group;
in response to the channel group being created, create a default chat channel included in the channel group; and
in response to an interaction from the user terminal requesting creation of a chat channel, create the chat channel included in the channel group.

13. A method for creating a channel group by a user terminal, the method comprising:
displaying a channel group creation interface for creating the channel group on a screen of the user terminal;
in response to an interaction from the user terminal with the channel group creation interface, requesting the server to create the channel group;
displaying a chat channel creation interface for creating a chat channel on the screen of the user terminal;
in response to an interaction from the user terminal with the chat channel creation interface, requesting the server to create the chat channel; and
displaying the channel group, including the chat channel, on the screen of the user terminal.

14. The method of claim 13, further comprising:
in response to an interaction from the user terminal with the chat channel creation interface, requesting the server to create a second chat channel; and
displaying the channel group, including the chat channel and the second chat channel on the screen of the user terminal.

15. The method of claim 14, further comprising:
receiving, from the server, a channel group address corresponding to the channel group, a first chat channel address corresponding to the chat channel, and a second chat channel address corresponding to the second chat channel.

16. The method of claim 13, wherein the channel group comprises at least one of the following: a group link for sharing at least one content and engaging in a group chat with a plurality of user accounts; a one-to-one channel group for engaging in a one-to-one chat with a different user account; and an open profile representing a user account of the user terminal on the channel group.

17. The method of claim 13, further comprising:
in response to an interaction from the user terminal with the channel group creation interface, requesting the server to create a second channel group.

18. The method of claim 17, further comprising:
receiving a channel group address corresponding to the channel group and a second channel group address corresponding to the second channel group from the server.
